(19) United States
(12) Patent Application Publication
(10) Pub. No.: US 2010/0040122 A1
(43) Pub. Date: Feb. 18, 2010

(54) SIMULTANEOUS BI-DIRECTIONAL DATA TRANSFER

(75) Inventors: Jean Barbier, Montpellier (FR); Olivier V. Lepape, Paris (FR)

Correspondence Address: SCHWABE, WILLIAMSON & WYATT, P.C., 1420 FIFTH, SUITE 3010, SEATTLE, WA, 98101, US

(73) Assignee: M2000 SA., Bievres (FR)

(21) Appl. No.: 12/190,352

(22) Filed: Aug. 12, 2008

(51) Int. Cl. H04B 1/40

(52) U.S. Cl. 375/220

(57) ABSTRACT

Embodiments provide methods, systems, and apparatuses including combinatorial or reconfigurable circuitry having input/output (I/O) circuitry with an I/O terminal and an input buffer. The I/O terminal receives a receive signal at a receive signal level that was transmitted from another integrated circuit at a transmitted signal level which is either a first or a second different signal level. The input buffer compares the receive signal to one or more reference signals to generate an input signal corresponding to the transmitted signal level based at least in part on the result of the comparison, even if the receive signal is received at a third signal level in between the first and the second signal level.

### FIELD OF THE INVENTION

Embodiments relate to the field of integrated circuits; in particular to integrated circuits with input/output circuitry to perform simultaneous bi-directional data transfer.

### BACKGROUND

Ever-larger systems are being implemented on single chips and the number of required input/output (I/O) signals on each of those chips is increasing as a result. But the number of I/O pads on an integrated circuit chip remains limited. Additionally, the speed of the integrated circuit cores has been increasing faster than the speed of the I/O. This drives an increase in the number of necessary I/O pads on a given chip.

Field Programmable Gate Arrays (FPGA) are employed in a wide variety of applications, including prototyping of large systems that will be implemented in more expensive Application Specific Integrated Circuits (ASIC). Prototyping allows system designers to run the prototyped system at hardware or near-hardware speeds to better evaluate performance and operation of the design. The prototype is often necessarily partitioned into multiple FPGA devices which in turn must be connected together consuming many I/O pads on each FPGA.

Techniques have been developed to increase the I/O capabilities of integrated circuits. Double Data Rate (DDR), for example, sends data using both edges of a clock but does not increase the inherent bandwidth of a connection. Moreover, such solutions are inherently synchronous and are not acceptable for applications requiring asynchronous data transfer. Also, bi-directional simultaneous signal transfer is described in “simultaneous Bidirectional Signaling [sic] for IC Systems” Computer Design: VLSI in Computers and Processors, 1990. ICCD '90. Proceedings, 1990 IEEE International Conference on 17-19 Sep. 1990 pp 430-433 written by Dally et al. Also, U.S. Pat. No. 5,604,450 titled “High Speed Bidirectional Signaling Scheme” describes a similar method. In both, a comparator subtracts a comparison voltage corresponding to the output voltage from a voltage at the I/O pad to extract the input voltage.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates two circuits for simultaneous, bi-directional data transfer in accordance with various embodiments;

FIG. 2 illustrates a timing diagram of two circuits performing simultaneous, bi-directional data transfer in accordance with various embodiments;

FIG. 3 illustrates a detailed view of two circuits for simultaneous, bi-directional data transfer in accordance with various embodiments;

FIGS. 4a-b illustrate timing diagrams of simultaneous, bi-directional data transfer in accordance with various embodiments;

FIGS. 5a and 5b illustrate timing diagrams showing potential glitches in signals when one signal transitions in accordance with various embodiments;

FIG. 6 illustrates a delay circuit for avoiding glitches in accordance with various embodiments;

FIG. 7 illustrates a system-wide view of two integrated circuits with a shared clock generating unit for synchronous operation in accordance with various embodiments; and

FIGS. 8 and 9 illustrate timing diagrams showing a data signal propagating from a transmitter to a receiver during synchronous operation in accordance with various embodiments.

### DETAILED DESCRIPTION OF EMBODIMENTS

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the disclosure. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent. Also, embodiments may have fewer operations than described. A description of multiple discrete operations should not be construed to imply that all operations are necessary. Also, embodiments may have fewer operations than described. A description of multiple discrete operations should not be construed to imply that all operations are necessary.

The description may use perspective-based descriptions such as up/down, back/front, and top/bottom. Such descriptions are merely used to facilitate the discussion and are not intended to restrict the application of embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments, are synonymous.

Embodiments provide integrated circuits—such as for example field-programmable gate arrays (FPGA) of other integrated circuit types—with sets of input/output (I/O) circuitry for simultaneous bi-directional signal or data transfer. One way to increase bandwidth communication between integrated circuits is to employ contention pads (i.e. I/O circuitry) capable of transmitting and receiving signals simultaneously, either synchronously or asynchronously. In embodiments, the I/O circuitry comprises logic to facilitate the simultaneous bi-directional signal or data transfer, without requiring other changes to the integrated circuit such as is required with other techniques for increasing I/O of an integrated circuit such as DDR.

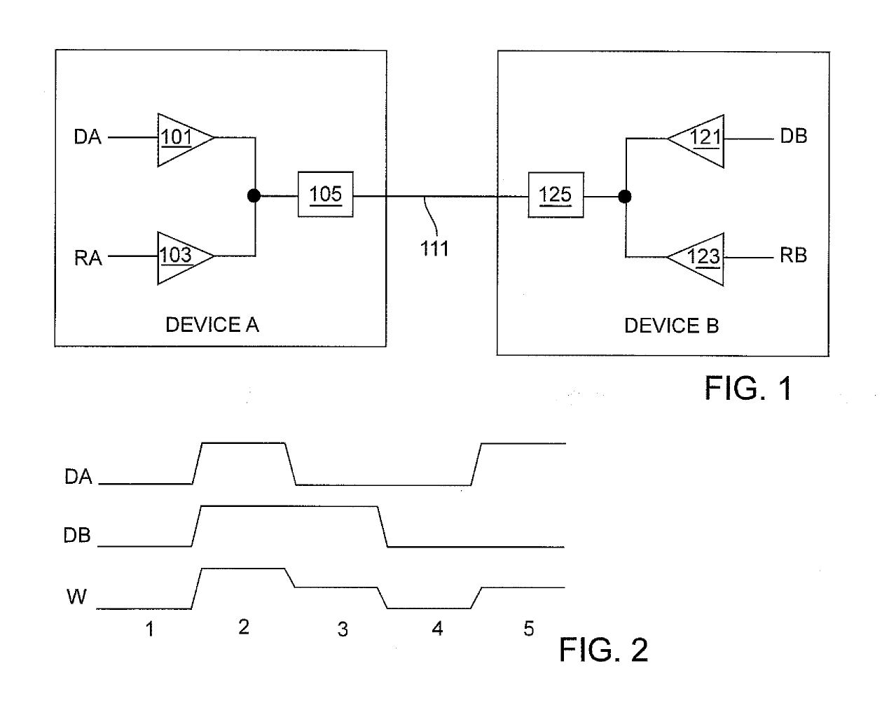

FIG. 1 illustrates two circuits for simultaneous, bi-directional data transfer in accordance with various embodiments. Each of devices A and B may be for example, an integrated circuit such as a FPGA having reconfigurable logic or an ASIC having combinatorial logic, or one FPGA, another ASIC. Output buffer 101 may be coupled to the combinatorial or reconfigurable logic (not shown), and configured to accept output data signal DA and drive it onto I/O terminal 105. Pad 105 may be coupled to device B via signal wire 111. Device B may also comprise a set of I/O circuitry. Signal wire 111 may be coupled to I/O terminal 125. Output buffer 121 of device B may likewise be coupled to combinatorial or reconfigurable logic (not shown) configured to accept output signal DB and drive it onto pad 125.

A resulting signal on I/O terminal 105 may result from the concurrent driving of output signal DA and output signal DB such that those signals appear at I/O terminal 105 at a particular point in time. It is not necessary—and will often not be the case—that DA and DB are driven simultaneously. Input buffer 103 of device A may be configured to accept the resulting signal. Input buffer 103 may include comparison circuitry (not shown) to compare the resulting signal level to one or more comparison voltages and to generate input signal RA corresponding to output signal DB, for the combinatorial or reconfigurable logic (not shown) coupled to input buffer 103. Output signal DB and output signal DA may, in embodiments, be either one of two different signal levels. In embodiments, if output signal DA and output signal DB are the same or substantially the same, then the resulting signal level on signal wire 111 may be substantially the same as DA and DB. But if output signal DA and output signal DB differ, then the resulting signal level may be an intermediate signal level, between DA and DB. In embodiments, input buffer 103 may be configured to generate input signal RA, depending on the results generated by the comparison circuit, corresponding to output signal level DB even if the resulting signal level is the intermediate signal level. Input buffer 123 of device B may be similarly configured, and contain the same or similar comparison circuitry, to perform the same function and produce input signal RB that corresponds to output signal DA, for the combinatorial or reconfigurable logic (not shown) coupled to input buffer 123, even if the resulting signal on I/O terminal 125 is an intermediate signal level.

The timing diagram of FIG. 2 may correspond, for example, to the simultaneous, bi-directional data transfer between the devices in FIG. 1 or other devices in accordance with various embodiments. Transitions in output signals DA and DB are shown. Resulting signal level W may correspond, for example, to the resulting signal level at I/O terminal 105 or, alternatively, at I/O terminal 125 in embodiments. For the purposes of illustration, the effects of propagation and other delays are not shown, but are discussed elsewhere within this specification.

During time phase 1, both DA and DB are at a low signal level and resulting signal level W may also be at a low signal level. At the beginning of time phase 2, both DA and DB transition to a high signal level and resulting signal level W may therefore also transition to the high signal level. But at time phase 3, DB may remain at the high signal level, but DA may transition to the low signal level. Accordingly, resulting signal level W may transition to an intermediate signal level. During time phase 4, W may transition to the low signal level as DA remains at the low signal level and DB transitions to the low signal level. At time phase 5, W may again be at the intermediate signal level as DA—but not DB—transitions to the high signal level. Other transitions may also be possible in embodiments, and embodiments are not limited to any one or set of transition states.

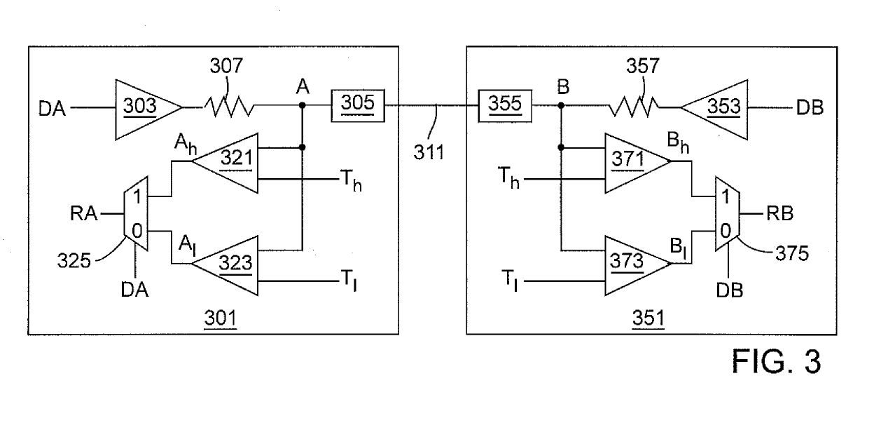

FIG. 3 illustrates a detailed view of two circuits for simultaneous, bi-directional data transfer in accordance with various embodiments. Device A and Device B may include one or more sets of I/O circuitry as depicted. Output buffer 303 may be coupled to I/O terminal 305 via resistor 307. Likewise, output buffer 353 may be coupled to I/O terminal 355 via resistor 357. In embodiments, output buffers 303 and 353 may be, for example, source-terminated drivers. In embodiments output buffer 303 may be configured to output signal DA and output buffer 353 may be configured to output signal DB. In embodiments, resistors 307 and 357 may have the same resistance, or substantially similar resistances. In embodiments, output signals DA and DB may be voltage signals. In such embodiments, the voltage signals may take on either a high voltage level corresponding to one binary level or a low voltage level corresponding to another binary level (e.g. a 1 or a 0). In embodiments, the high voltage level may be V_{dd} or other voltage. In embodiments, the low voltage level may be 0 Volts or other voltage. In embodiments where the signals are voltage signals, resistor 307 and resistor 357 may, along with signal wire 311, act as a voltage divider.

Device 301 may also include an input buffer comprising comparator 321, comparator 323, and multiplexer 325. Likewise, device 351 may comprise an input buffer including comparator 371, comparator 373, and multiplexer 375. Comparators 321 and/or 371 may be configured to compare a resulting voltage on either I/O terminal 305 or 355 to a first comparison voltage Tₕ. Comparators 323 and/or 373 may be configured to compare the resulting voltage on either I/O terminal 305 or 355 to a second comparison voltage Tₗ. Tₕ may, in embodiments, be a signal level between a high signal level and an intermediate signal level. In embodiments, Tₗ may be a signal level between a low signal level and the intermediate signal level. Depending on the results of the comparisons of comparators 321 and 323, (represented by signals (e.g. voltages) Aₕ and Aₗ) for example, multiplexer 325 may generate an input signal RA corresponding to the output signal level DB. Comparators 371 and 373 and multiplexer 375 may be configured to operate in a similar way to generate input signal RB corresponding to output signal DA depending on the signals Bₕ and Bₗ.

Table 1 depicts various voltage levels that may exist depending on various combinations of output voltages DA and DB, in accordance with embodiments. Table 1 represents only voltages on Device 301, but similar results may be produced by the I/O circuitry of device 351. For the purposes of illustration only, the high voltage is represented as 1 Volt, the low voltage is represented by 0 Volt, and the intermediate voltage is represented by 0.5 Volt. But embodiments are not limited to these or any other sets of voltages. Even though voltages are used in table 1, the signals may also be current levels in alternative embodiments.

TABLE 1

| DA | DB | W | Ah | Al | RA |
|---|---|---|---|---|---|
| 0 | 0 | 0 | 0 | 0 | 0 |
| 0 | 1 | 0.5 | 0 | 1 | 1 |
| 1 | 0 | 0.5 | 0 | 1 | 0 |
| 1 | 1 | 1 | 1 | 1 | 1 |

As can be seen, in embodiments, if DA and DB differ, then the resulting voltage W will be the intermediate voltage—0.5 Volts—as a result of the voltage divider formed by resistors 307 and 357. When resulting voltage W is at the intermediate voltage level, the output of comparator 321 may be 0 (because, for example, the comparison voltage Tₕ may be higher than resulting voltage W) and the output of comparator 323 may be 1 (because, for example, the comparison voltage Tₗ may be lower than resulting voltage W).

Multiplexer 325 may be configured to accept DA as a reference. In embodiments, multiplexer 325 may be configured to select Aₗ as an output voltage when DA is 0 Volts and to select Aₕ when DA is 1 Volts. Thus, when DA is 0 Volts, multiplexer 325 may generate an input voltage RA of 1 Volts when Aₕ and Aₗ differ by selecting Al as the input voltage. Similarly, when DA is 1 Volt, multiplexer 325 may generate an input voltage of 0 Volts whenever Aₕ and Aₗ differ by selecting Ah as the input voltage. In this way, various embodiments are able to generate input signal RA that corresponds to the output voltage DB even if the comparison outputs indicate that resulting signal W is at the intermediate signal level. The input buffer of device 351 may be similarly configured to generate an output voltage RB—corresponding to output voltage DA—depending on the Bh and Bl outputs of comparators 371 and 373, respectively. In alternative embodiments not shown, a different circuit may be utilized that is configured to compare Aₕ and Aₗ and to generate an output RA that is the opposite of DA when Aₕ and Aₗ differ and which generates an output RA that is the same as DA whenever Aₕ and Aₗ are the same.

In alternative embodiments, currents may be used for signal levels rather than voltages. In embodiments, signal wire 311 may have an impedance that matches the resistances of resistors 307 and 357.

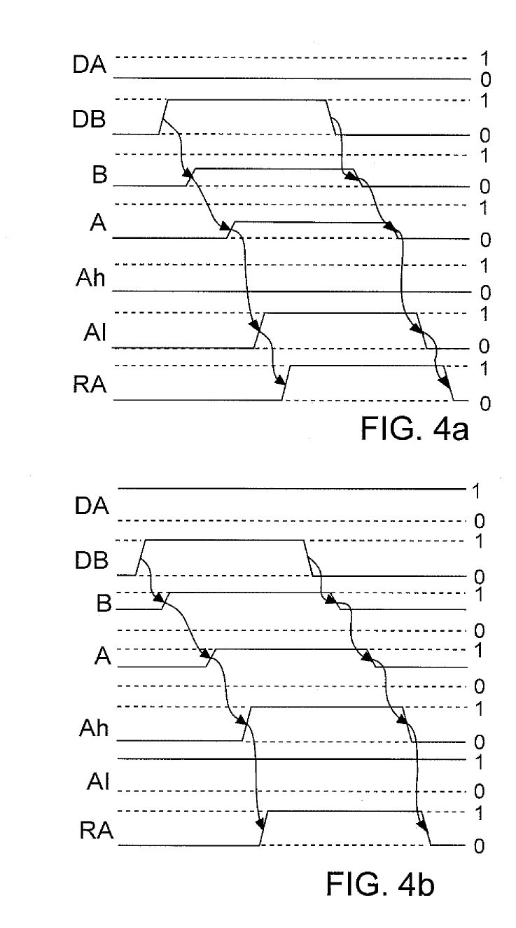

The timing diagrams of FIGS. 4a-b illustrate timing diagrams of simultaneous bi-directional signal or data transfer in accordance with various embodiments. These timing diagrams may, in embodiments, correspond with signal transfer according to embodiments illustrated in FIG. 3 or other embodiments. Propagation delays may, in embodiments, need to be accounted for. In FIG. 4a, when DB transitions from a low signal level to a high signal level, the signal level at nodes A and B (in FIG. 3) will also transition to an intermediate signal level because DA and DB are now different. But signal propagation delay will cause these transitions to occur sometime after the transition of signal DB. Because of the transition of signal DB, signal Al (also from FIG. 3) may transition to a high state some time later than the transition of node A which subsequently causes generated input signal RA to transition. A similar change is shown in FIG. 4(b).

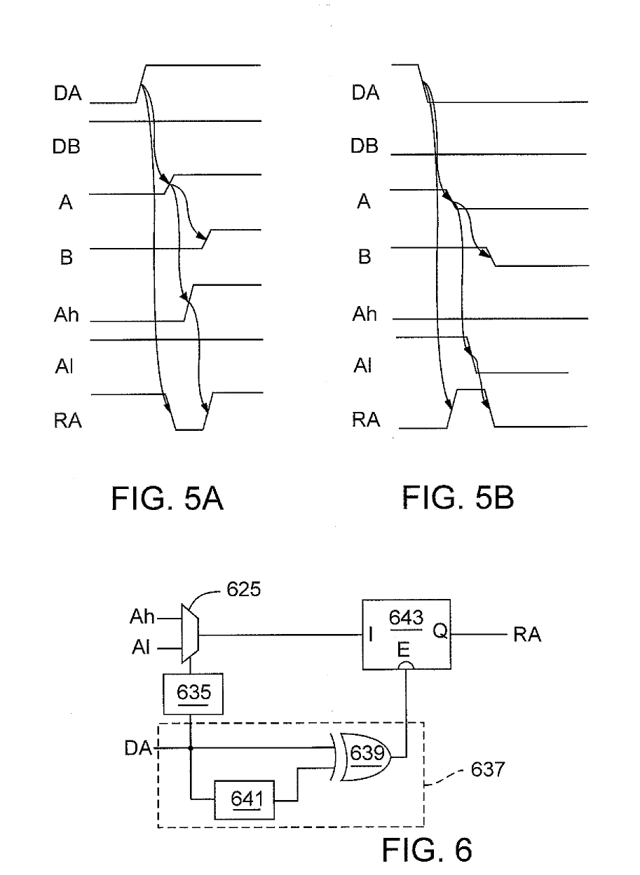

FIGS. 5a and 5b illustrate timing diagrams showing glitches in signals when one signal transitions in accordance with various embodiments. The timing diagram of FIGS. 5a-5b may, in embodiments, correspond to signal transfer according to embodiments illustrated in FIG. 3 or other embodiments. Here, unlike in the case depicted in FIGS. 4a-b, it may be DA that transitions to a new state rather than DB. In embodiments, this may result in a glitch in the value of RA. This glitch may result because—as described with reference to FIG. 3 above—multiplexer 325 may be configured to use DA to select the multiplexer inputs Al and Ah to generate input signal RA.

Thus, referring for example to FIG. 5a, during an initial state, DA and DB differ resulting in an intermediate signal level at node A. Thus, during this time, Aₕ and Aₗ also differ and multiplexer 325 uses DA to select either Aₕ or Aₗ to generate input signal RA. But Aₕ takes a period of time to transition from a low to a high level due to circuit propagation delay. But DA immediately changes. Thus multiplexer 325 inputs Aₕ and Aₗ may indicate that the signal at node A remains at the intermediate signal level, and multiplexer 325 may accordingly select the opposite of the newly-transitioned DA as shown at the bottom of FIG. 5a. Thus, RA does not, for a brief time, correspond to DB. But once Aₕ completes its transition, RA returns to normal. FIG. 5b illustrates a similar glitch.

FIG. 6 illustrates a delay circuit configured to avoid glitches in accordance with various embodiments. To avoid sampling the output during the time that a glitch may occur (as depicted for example in FIG. 5a-b), embodiments may be configured to delay inputting DA into multiplexer 625. The circuit in FIG. 6 is one such delay circuit according to embodiments. Multiplexer 625 may be, for example, the same as multiplexer 325 from FIG. 3 or other multiplexer according to other embodiments. Multiplexer 625 accepts as input Ah and Al as described elsewhere, as well as DA. Delay line 635 is disposed between an output buffer and multiplexer 625 to delay the transition of DA into the input of latch 643. Delay 635 may be configured to match the delay from DA through a comparator such as for example the comparators shown in FIG. 3 (e.g. comparators 321 and 323 of FIG. 3) and a multiplexer (e.g. multiplexer 325 of FIG. 3 which may be similar or identical to multiplexer 625 in embodiments). Adding this delay may reduce the duration of the glitch illustrated in FIGS. 5A and 5B. Although FIG. 6 shows delay circuit 637 and latch 643, in embodiments, delay circuit 637 and latch 643 may be eliminated. In the embodiment shown in FIG. 6, latch 643 may be coupled to an output of multiplexer 625. Latch 643 may have an input I for accepting the output of multiplexer 625, an output Q to present input signal RA to internal logic of the integrated circuit, and a latch enable input E to enable the latch to reproduce the signal at input I at the output Q. When enable E is set to a certain value (such as for example a binary logic “0”), latch 643 may be configured to hold a value at output Q even if input I changes.

Delay circuit 637 may be disposed between an output buffer and latch 643 and may include delay line 641 coupled between output signal DA and exclusive-or (XOR) gate 639. XOR 639 may produce a binary logic “1” whenever its inputs differ. When DA is stable, the XOR 639 inputs may be the same and XOR 639 may output a binary logic 0. In such cases, latch 643 may allow a signal at input I to propagate to output Q. But when DA transitions, there is a time period defined by delay 641, during which the inputs to XOR 639 may differ and accordingly produce an XOR output of “1”. During this time, latch 643 may maintain the output value, and ignore the input from multiplexer 625. After the time period defined by delay 641, the output of XOR 639 may return to “0” and latch 643 may allow the signal at input I to propagate to output Q. In embodiments, the delay of delay 641 may be long enough to mask the glitch, as previously described. In embodiments, the delay of delay 641 may be longer than the time it takes for a transition in DA to result in a new value on the output of the multiplexer, and input I of the latch.

Delay line 635 may be configured to cause output signal DA to be delayed longer than the total delay of XOR 639 and the amount of time it takes for latch 643 to latch. In this way, any glitch in the output of multiplexer 625 caused by a transition of DA may not propagate to input I of latch 643 before latch 643 has a chance to latch the previous signal at input I. Other embodiments of delay circuit 637 may include components other than delay line 641 and/or XOR 639. Embodiments are not limited to any type or types of delay circuits. Embodiments employing a delay circuit such as the one illustrated in FIG. 6 may be configured to perform asynchronous signal or data transfer.

In the embodiments shown in FIG. 6, latch 643 may be enabled when the latch input E is high (e.g. 1 Volts in embodiments). In alternative embodiments, latch 643 may be enabled when latch input E is low (e.g. 0 volts in embodiments). In such embodiments, XOR 639 may be replaced by an XNOR circuit. Or, alternatively, an inverter may be placed between XOR 639 and latch 643. Embodiments are not limited to any one circuit arrangement or sets of circuit arrangements.

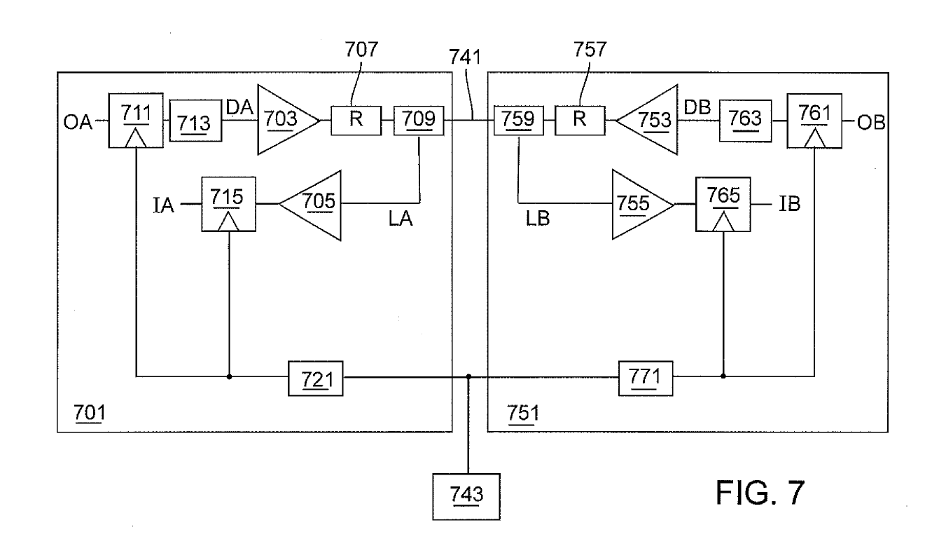

FIG. 7 illustrates a system-wide view of two integrated circuits with a shared clock generating unit for synchronous operation in accordance with various embodiments. By utilizing synchronous data or signal transfer, embodiments may not require a delay circuit—such as for example the delay circuit shown in FIG. 6—to avoid glitches as illustrated in FIGS. 5a-b. Device 701 may be coupled to device 751 via signal wire 741. Device 701 may also be coupled to clock generation circuit 743 via clock circuit 721 which may be, in embodiments, a phase lock loop (PLL) circuit. In alternate embodiments, device 701, device 751, or another integrated circuit may provide a clock signal. Output buffer 703 may be configured to output an output signal at one of two signal levels, as described elsewhere within this specification. Output buffer 703 may be coupled to I/O terminal 709 via resistor 707. In embodiments, the resistance of resistor 707 may match or substantially match an impedance of signal wire 741. Input buffer 705 may be configured to compare a resulting signal on I/O terminal 709 to one or more comparison signals to generate an input signal corresponding to an output signal output by output buffer 753 of device 751 as described elsewhere within this specification.

Transmit register 711 may be configured to sample an output data signal according to a transmit clock signal such as, for example, on either a rising or falling edge of the clock signal. Delay line 713 may be configured and/or programmed to delay the sampled output data signal from being input into output buffer 703. In embodiments, delay line 763 may be configured and/or programmed with the same delay. Receive register 715 may be configured to sample a signal from input buffer 705 according to a receive clock signal which may be, in embodiments, the same as the transmit clock signal. In general, I/O terminal 759, resistor 757, output buffer 753, transmit register 761, input buffer 755, input register 765, and clock circuit 771 within device 751 may be the same or substantially similar to their counterparts in device 701.

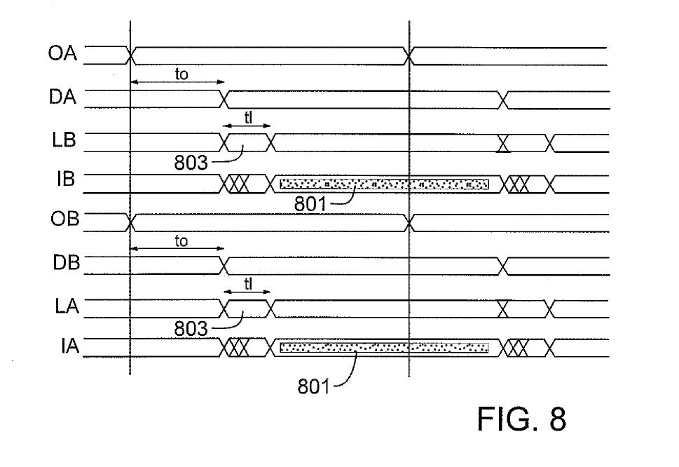

FIG. 8 illustrates a timing diagram showing two simultaneous data signals propagating between two integrated circuits during synchronous operation in accordance with various embodiments. In embodiments, signals OA, DA, LB, RB, OB, DB, LA, and RA may refer to signal labels as depicted in FIG. 7. The timing diagram of FIG. 8 may, for example, correspond to signals propagating between device 701 and 751 of FIG. 7. The output data signal OA may be clocked by transmit register 711 at either a rising or falling edge of a clock signal (shown by the vertical line). After a delay to representing a combined delay given by delay line 713 and output buffer 703, the output signal outputted by the output buffer may transition from one state to another. Signal DA as shown in FIG. 8 corresponds to the signal indicated as DA in FIG. 7 between delay 713 and output buffer 703. The time period tₗ represents a transmission delay across signal wire 741 to device 751. Input buffer 755 may produce glitch 803 for reasons similar to those discussed in regards to FIG. 5 above. Input register 765 may be configured to sample the output of input buffer 755 according to a shared clock signal in order to sample during validity window 801 which may occur after glitch 803. The same or similar timing flow may also occur in the opposite direction; that is, a signal or data transmission from device 751 to 701. In this way, synchronous data or signal transfer may be accomplished in embodiments. Also a shared clock signal may eliminate the need for a delay circuit, such as the delay circuit depicted in FIG. 6. In embodiments, the delay of delay circuit 713 may be programmed to time the validity window such that the clock signal edge is substantially centered in the validity window In alternative embodiments, a delay can be inserted on the input of transmit register 711 and/or transmit register 761 to allow a receiver clock to be out of phase with respect to a transmit clock to allow more flexibility in sampling the received data signal in the center of the validity window. FIG. 8 also shows signals propagating, for example, from device 751 to device 701 of FIG. 7. Similar glitch 803 and validity window 801 may also occur in that direction as depicted in FIG. 8. While FIG. 8 shows substantially similar transmissions occurring in both directions, embodiments are not so limited.

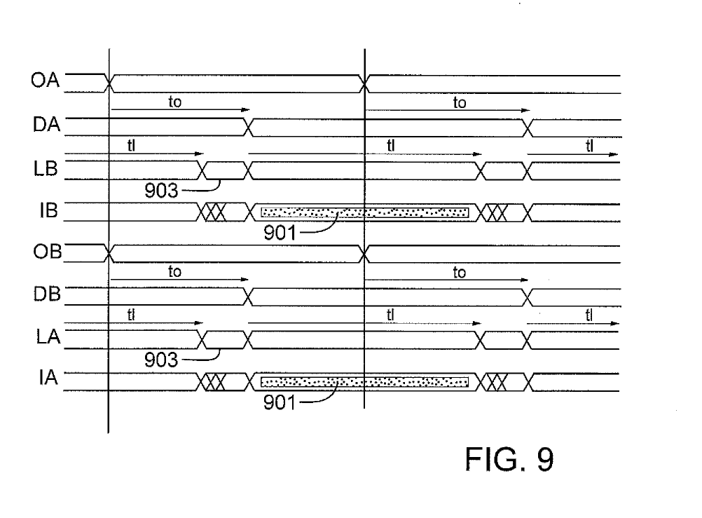

As shown in FIG. 9, in embodiments the transition of output signal DA may not be received by device 751 (received as signal LB) until after the next clock cycle. In embodiments, this transmission delay may be several clock cycles. This may not affect the bandwidth at which signals can be transmitted because several signals may simultaneously exist on the signal wire. In embodiments, the size of validity windows 801 and/or 901 may depend on the value of tₗ. In some embodiments, the size of validity windows 801 and/or 901 may be less than 50% of tₗ. In some embodiments, the size of validity windows 801 and/or 901 may be increased by sampling on the opposite edge of the clock than the signal is transmitted on. As with FIG. 8, FIG. 9 shows substantially similar transmissions occurring in both directions, but embodiments are not so limited.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the disclosure. Those with skill in the art will readily appreciate that embodiments of the disclosure may be implemented in a very wide variety of ways. This application is intended to cover any adaptations or variations of the embodiments discussed herein. Therefore, it is manifestly intended that embodiments of the disclosure be limited only by the claims and the equivalents thereof.

What is claimed is:

1. An integrated circuit comprising:
combinatorial or reconfigurable circuitry; and
a set of input/output (I/O) circuitry coupled to the combinatorial or reconfigurable circuitry, wherein the I/O circuitry comprises an I/O terminal and an input buffer coupled to the I/O terminal, wherein the I/O terminal is configured to receive a receive signal at a receive signal level, the receive signal transmitted from another integrated circuit at a transmitted signal level which is either a first or a second different signal level, and wherein the input buffer comprises comparison circuitry configured to compare the receive signal to one or more reference signals to enable the input buffer to generate an input signal corresponding to the transmitted signal level based at least in part on the result of the comparison(s), even if the receive signal is received at a third signal level in between the first and the second signal level.

2. The integrated circuit of claim 1 wherein the input buffer is configured to determine if the receive signal level is the third signal level by comparing the resulting signal level to a first reference signal level and to a second reference signal level of the one or more reference signals.

3. The integrated circuit of claim 2 wherein the first reference signal level is between the first signal level and the third signal level and the second reference signal level is between the third signal level and the second signal level, and wherein the input buffer comprises a first comparator configured to compare the receive signal level with the first reference signal level and a second comparator to compare the receive signal level with the second reference signal level.

4. The integrated circuit of claim 3 wherein the input buffer is configured to determine from outputs of the comparators whether the receive signal level is the intermediate signal level.

5. The integrated circuit of claim 2 wherein the signal levels are voltage levels.

6. The integrated circuit of claim 1 wherein the I/O circuitry comprises an output buffer to output an output signal at an output signal level and a resistor disposed between the output buffer and the I/O terminal, to form a voltage divider along with another resistor of the other integrated circuit when the integrated circuit is coupled to the other integrated circuit via a signal wire, and wherein the voltage divider causes the receive signal to be the third signal level when the output signal level and the transmit signal level differ.

7. The integrated circuit of claim 1 wherein the set of I/O circuitry further comprises an output buffer to output an output signal at an output signal level and wherein the input buffer further comprises an input latch disposed at an output of the input buffer and a delay circuit coupled between the output buffer and a latch enable input of the input latch, the delay circuit configured to temporarily disable the latch enable when the output signal level changes to delay a transition of an input latch output.

8. The integrated circuit of claim 1 wherein the integrated circuit is configured to receive and transmit asynchronously.

9. The integrated circuit of claim 1 further comprising:
an output buffer to output an output signal at an output signal level;
a transmit register coupled to the output buffer and configured to sample an output data signal according to a clock signal; and
a transmit delay coupled between the transmit register and the output buffer to delay providing the output data signal to the output buffer by a specific interval;
wherein the other integrated circuit is configured to transmit the receive signal according to the clock signal and to employ the specific interval to delay the transmitting, to enable synchronous communication between the integrated circuit and the other integrated circuit.

10. The integrated circuit of claim 1 wherein the set of I/O circuitry is one of a plurality of sets of I/O circuitry of the integrated circuit.

11. The integrated circuit of claim 1 wherein the combinatorial or reconfigurable circuitry comprises a plurality of reconfigurable crossbars and/or a plurality of reconfigurable gate arrays.

12. An apparatus comprising:
means for receiving a receive signal at a receive signal level transmitted by another apparatus, the receive signal transmitted by the other apparatus at a transmit signal level that is either a high signal level or a low signal level different from the high signal level;
means for comparing the receive signal to one or more reference signals to produce a comparison; and
means for generating an input signal at an input signal level, corresponding to the transmit signal level, based at least upon the comparison even if the receive signal level is an intermediate signal level between the high and the low signal levels.

13. The apparatus of claim 12 wherein the one or more reference signal levels comprise a first reference signal level between the high signal level and the intermediate signal level, and a second reference signal level between the low signal level and the intermediate signal level, and wherein the means for comparing the receive signal comprises means for comparing the receive signal to the first reference signal level and for comparing the receive signal to the to second reference signal level to determine whether the receive signal is the intermediate signal level.

14. The apparatus of claim 12 further comprising means for outputting an output signal at an output signal level and means for causing the receive signal level to be the intermediate signal level when the transmit signal level and the output signal level differ.

15. The apparatus of claim 12 further comprising means for holding the generated input signal level steady for a predetermined period of time after the output signal level transitions from one state to another.

16. The apparatus of claim 12 further comprising:
means for outputting an output signal at an output signal level;
means for sampling an output data signal according to a clock signal and providing the sampled output data signal to the means for outputting the output signal;
means for delaying providing the sampled output data by a predetermined time period.

17. A system comprising:
a signal wire;
a first integrated circuit having a first set of I/O circuitry having a first I/O terminal coupled to the signal wire, a first input buffer, and a first output buffer to output a first output signal at a first output signal level via the first I/O terminal, wherein the first output signal level is either a high signal level or a low signal level; and
a second integrated circuit comprising:
a second set of input/output (I/O) circuitry comprising:
a second I/O terminal coupled to the signal wire;
a second output buffer to output a second output signal at a second output signal level on the signal wire via the second I/O terminal; and
a second input buffer coupled to the second I/O terminal, and configured to receive the first output signal on the signal wire at a receive signal level, and wherein the second input buffer comprises comparison circuitry configured to compare the receive signal level to one or more reference signal levels to enable the second input buffer to generate an input signal corresponding to the first output signal based at least in part on the result of the comparison(s), even if the receive signal level is an intermediate signal level between the low and the high signal level.

18. The system of claim 17 wherein the second integrated circuit comprises a second resistor disposed between the second output buffer and the second I/O terminal, and wherein the first integrated circuit comprises a first resistor disposed between the first I/O terminal and the first output buffer, the first and second resistors forming a voltage divider to cause the receive signal level to be the intermediate signal level when the first output signal level and the second output signal level differ.

19. The system of claim 17 wherein the receive signal level is a second receive signal level, the input signal is a second input signal, the comparison circuitry is a second comparison circuitry, and wherein the first input buffer is configured to receive the second output signal at a first receive signal level, wherein the second output buffer is configured to transmit the second output signal at a second transmit level that is either the high or the low signal level, and wherein the first input buffer comprises first comparison circuitry configured to compare the first receive signal level to one or more reference signal levels to enable the first input buffer to generate a first input signal level corresponding to the second transmit signal level based at least in part on the result of the comparison(s), even if the first receive signal level is received at the intermediate signal.

20. The system of claim 19 further comprising a clock generation device coupled to the first integrated circuit and the second integrated circuit, and wherein the first set of I/O circuitry and the second set of I/O circuitry are both configured to operate according to a clock signal from the clock generation device.

21. The system of claim 19 further comprising:
a clock generation device coupled to the first integrated circuit and the second integrated circuit and configured to provide a clock signal, and wherein:
the first integrated circuit comprises a first transmit register coupled to the first output buffer and configured to sample a first output data signal according to the clock signal, and a first transmit delay coupled between the first transmit register and the first output buffer to delay the first output data signal to the first output buffer by a specific interval; and
the second integrated circuit comprises a second transmit register coupled to the second output buffer and configured to sample a second output data signal according to the clock signal, and a second transmit delay coupled between the second transmit register and the second output buffer to delay the second output data signal to the second output buffer by the specific interval.
